(19) United States
(12) Patent Application Publication
(10) Pub. No.: US 2001/0043969 A1
(43) Pub. Date: Nov. 22, 2001

(54) Edible colored cookie, method for coloring same, coloring tool and a kit containing a cookie and a coloring tool

(76) Inventor: David Wild, Plainview, NY (US)

Correspondence Address: Thomas M. Galgano, Suite 135, 300 Rabro Drive, Hauppauge, NY, 11788, US

(21) Appl. No.: 09/837,768

(22) Filed: Apr. 18, 2001

Related U.S. Application Data
(60) Provisional application No. 60/198,048, filed on Apr. 18, 2000.

(51) Int. Cl. A23L 1/27

(52) U.S. Cl. 426/87; 426/104; 426/94; 426/250

(57) ABSTRACT

An edible confection includes a cookie having white icing imprinted with a black edible ink outline of an image suitable for coloring. According to the invention, the cookies are distributed with one or more fruit flavored alcohol based ink markers. According to the presently preferred embodiment, the cookies are shaped to conform to the general outline of the image borne thereon. The presently preferred ink markers contain a mixture of water, glycerine, ethyl alcohol, flavoring, and food dyes. The cookies of the invention are preferably distributed in groups of thematically related images. Some thematic images contemplated by the invention include farm animals, zoo animals, reptiles, fish, holiday themes, licensed characters, etc. According to one embodiment, indicia are provided on the icing of the cookie to indicate what colors should be used to color each portion of the image. According to another embodiment, the edible ink markers can be used to color other edible items such as cakes, fondants, fruits, glazes, gum or rice paper. According to still other embodiments, colorable confections are provided in the form of greeting cards, post cards, and holiday ornaments.

This application claims the benefit of provisional application Ser. No. 60/198,048 filed Apr. 18, 2000, the complete disclosure of which is hereby incorporated by reference herein and provisional application Ser. No. ______ filed Mar. 19, 2001.

### BACKGROUND OF THE INVENTION

1. Field of the Invention

The invention relates to edible confections and to childhood amusements. More particularly, the invention relates to an edible cookie bearing a colorable image and kits containing such cookies with edible ink coloring markers.

2. State of the Art

It is generally known in the art of confections to provide cookies which bear images. Images are applied by the baker using edible coloring agents. It is also know in the art childhood amusements to provide “coloring books” which contain black and white outline images to be colored in with crayons, colored pencils, or ink markers, Children are amused by the process or coloring in the images.

Heretofore, it has not been known or suggested to combine features of edible confections with childhood amusements. More particularly, it has not been known or suggested to combine features of cookies with features of coloring books.

### SUMMARY OF THE INVENTION

It is therefore an object of the invention to provide an edible confection.

It is also an object of the invention to provide a childhood amusement.

It is another object of the invention to provide an amusing activity for children.

It is still another object of the invention to provide a kit containing an edible confection and a coloring tool.

In accord with these objects which will be discussed in detail below, the edible confection of the present invention includes a cookie preferably having white icing imprinted with a black edible ink outline of an image suitable for coloring. According to the invention, the cookies are distributed with one or more fruit flavored alcohol based ink markers. According to the presently preferred embodiment, the cookies are shaped to conform to the general outline of the image borne thereon. The presently preferred ink markers contain a mixture of water, glycerine, ethyl alcohol, flavoring, and food dyes. The cookies of the invention are preferably distributed in groups of thematically related images. Some thematic images contemplated by the invention include farm animals, zoo animals, reptiles, fish, holiday themes, licensed characters, etc. Moreover, cookies bearing corporate logos make suitable gifts for children of employees.

The methods of coloring the cookie ray be undertaken as an individual or group activity. According to one embodiment, indicia are provided on the icing of the cookie to indicate what colors should be used to color each portion of the image. According to another embodiment, the edible ink markers can be used to color other edible items such as cakes, fondants, fruits, glazes, gum or rice paper. According to still other embodiments, colorable confections are provided in the form of greeting cards, pout cards, and holiday ornaments.

Additional objects and advantages of the invention will become apparent to those skilled in the art upon reference to the detailed description taken in conjunction with the provided figures.

### BRIEF DESCRIPTION OF THE DRAWINGS

FIG. 1 is a plan view of an exemplary embodiment of a cookie according to the invention; and

FIG. 2 is a plan view of a kit according to the invention.

### DETAILED DESCRIPTION OF THE PREFERRED EMBODIMENTS

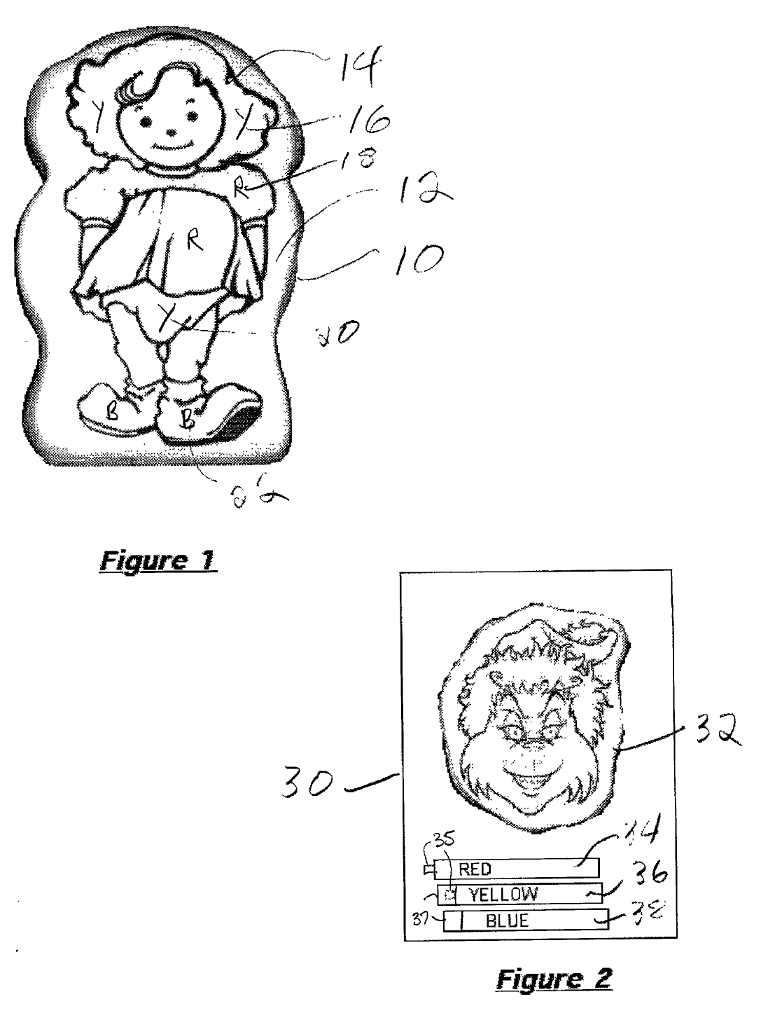

Referring now to FIG. 1, an edible confection 10 according to the invention includes a top surface 12 which is imprinted with an outline image 14. According to the presently preferred embodiment, the top surface 12 includes a white icing and the image 14 is imprinted on the icing with an edible black ink. The white icing is adapted to receive thereon edible inks of other color than black.

According to one embodiment of the invention, the image 14 is provided with indicia 16, 18, 20, 22 indicating color codes; alternatively, the color codes could be identified in the packaging for the cookie. According to the presently preferred embodiment, the edible confection is a cookie and is shaped to conform to the general outline of the image 14 borne thereon. The cookies are preferably distributed in groups of thematically related images. Some thematic images contemplated by the invention include farm animals, zoo animals, reptiles, fish, holiday themes, licensed characters, etc. Moreover, cookies bearing corporate logos make suitable gifts for children or employees.

Referring now to FIG. 2, according to the invention, a kit 30 is provided containing one or more cookies 32 with one or more fruit flavrored alcohol based ink markers 34, 36, 38.

The presently preferred ink markers contain a mixture or water, glycerine, ethyl alcohol, flavoring, and food dyes.

A first example of an edible ink according to the invention in set forth in Table 1. below.

TABLE 1

| Ingredient | Relative Amount |
|---|---|
| Water | 36.59% |
| Glycerine | 30.96% |
| Ethyl Alcohol | 28.14% |
| FD&C Coloring | 2.81% |
| Flavoring | 2.5% |

According to the invention, the FD&C coloring includes one or more of the following edible dyes: FD&C yellow #5, FD&C blue #1, FD&C red #40, and FD&C red #3.

Another formulation of an edible ink according to the invention is set forth in Table 2, below.

TABLE 2

| Ingredient | Quantity |
|---|---|
| Water | 27,300 grams |
| Glycerine | 23,100 grams |
| Ethyl Alcohol | 21,000 grams |
| Flavoring | 1,070 grams |
| Food Dyes | according to color |

According to the invention, the flavoring is preferably a natural or artificial fruit flavoring. The edible ink is preferably dispensed from a conventional felt or porous plastic tip marker 34, 36, 38 having felt or porous plastic tip applicators 35 normally covered by caps 37. The ink is fast drying when applied, but slow drying in the marker. According to the invention, a marker containing ink according to the invention can be left uncovered for six hours without drying out. Alternatively, conventional paint markers could be used.

The methods of coloring the cookie may be undertaken as an individual or group activity. According to another embodiment, the edible ink markers can be used to color other edible items such as cakes, fondants, fruits, glazes, gum or rice paper. According to still other embodiments, colorable confections are provided in the form of greeting cards, post cards, and holiday ornaments.

There have been described and illustrated herein several embodiments of an edible confection, methods for coloring it, and a kit containing an edible confection and coloring tools. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

1. An edible confection, comprising:
a) a base layer; and
b) an icing layer, wherein
said icing layer is imprinted with an image suitable for coloring and said icing layer is adapted to receive an edible coloring.

2. An edible confection according to claim 1, wherein:
said icing layer is imprinted with indicia indicating a color code.

3. An edible confection according to claim 1, wherein:
said base layer has a shape conforming to the outline of said image.

4. An edible confection according to claim 1, wherein:
said image is selected from the group consisting of farm animals, zoo animals, reptiles, fish, holiday themes, and licensed characters.

5. An edible confection according to claim 1, wherein:
said edible confection is a cookie.

6. An edible confection according to claim 1, wherein:
said edible confection is in the form of a holiday ornament.

7. An edible confection according to claim 1, wherein:
said edible confection is in the form of a greeting card.

8. An edible confection according to claim 1, wherein:
said edible confection is in the form of a post card.

9. A kit, comprising:
a) an edible confection imprinted with an image suitable for coloring; and
b) at least one coloring tool.

10. A kit according to claim 9, wherein:
said at least one coloring tool includes at least two different colored coloring tools, and
said edible confection is imprinted with indicia indicating color codes.

11. A kit according to claim 9, wherein:
said edible confection has a shape conforming to the outline of said image.

12. A kit according to claim 9, wherein:
said image is selected from the group consisting of farm animals, zoo animals, reptiles, fish, holiday themes, and licensed characters.

13. A kit according to claim 9, wherein:
said edible confection is a cookie.

14. A kit according to claim 9, wherein:
said edible confection is in the form of a holiday ornament.

15. A kit according to claim 9, wherein:
said edible confection is in the form of a greeting card.

16. A kit according to claim 9, wherein:
said edible confection is in the form of post card.

17. A method of coloring an edible confection, comprising:
a) imprinting the confection with an outline image suitable for coloring; and
b) distributing the edible confection with at least one coloring tool.

18. A method according to claim 17, further comprising:
c) filling in a portion of the outline image using the coloring tool.

19. A method according to claim 17, wherein:
said step of distributing includes distributing the edible confection with at least two different colored coloring tools.

20. A method according to claim 19, further comprising;
c) coloring in a portion of the outline image using one coloring tool; and
d) coloring in another portion of the outline image using another coloring tool.

21. An edible ink, comprising:
a water;
b) glycerine;
c) ethyl alcohol;
d) fruit flavor; and
e) a dye selected from the group consisting of FD&C yellow, #5, FD&C blue #1, FD&C red #40, and FD&C red #3.

22. A coloring tool comprising a hand holdable housing having an ink reservoir and an applicator in fluid communication with said ink reservoir; and
a fruit-flavored edible ink received in said reservoir.

23. The coloring tool according to claim 22 wherein said housing is a marker and said applicator comprises a felt tip.

24. The coloring tool according to claim 22, wherein said housing is a marker and said applicator comprises a porous plastic tip.

25. The coloring tool according to claim 21 wherein said edible ink comprises:
a) water;
b) glycerine;
c) ethyl alcohol;
d) fruit flavor; and
e) a dye selected from the group consisting of FD&C yellow #5, FD&C blue #1, FD&C red #40, and FD&C red #3.
